(19) United States
(12) Patent Application Publication
(10) Pub. No.: US 2008/0101402 A1
(43) Pub. Date: May 1, 2008

(54) NETWORK COMMUNICATION APPARATUS AND RELATED METHOD THEREOF

(76) Inventors: Jung-You Feng, Hsin-Chu City (TW); Chen-Chih Huang, Hsin-Chu Hsien (TW); Po-Wei Liu, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/968,657

(22) Filed: Jan. 3, 2008

Related U.S. Application Data
(63) Continuation-in-part of application No. 10/906,089, filed on Feb. 2, 2005.

(30) Foreign Application Priority Data
Jan. 4, 2007 (TW) 096100288
Feb. 4, 2004 (TW) 093102487

(51) Int. Cl. H04L 12/66

(52) U.S. Cl. 370/463

(57) ABSTRACT

The present invention provides a communication apparatus. The communication apparatus includes a first processing circuit for processing data of a first network layer to generate a first parallel data; a parallel-to-serial converting unit coupled to the first processing circuit for generating a serial data according to the first parallel data generated by the first processing circuit; a transmitting interface coupled to the parallel-to-serial converting unit for transmitting the serial data generated by the parallel-to-serial converting unit; a serial-to-parallel converting unit coupled to the transmitting interface for converting the serial data transmitted by the transmitting interface into a second parallel data; and a second processing circuit for processing the second parallel data to generate data corresponding to a second network layer; wherein a transmitting frequency of the transmitting interface is different from operating frequencies of the first and the second processing circuit.

### CROSS REFERENCE TO RELATED APPLICATIONS

This application is a continuation-in-part of applicant's earlier application, Ser. No. 10/906,089, filed on Feb. 2, 2005, which is included herein by reference.

### BACKGROUND OF THE INVENTION

1. Field of the Invention

The present invention relates to a communication apparatus, and more particularly to a communication apparatus that transmits data in the form of serial data, and a method thereof.

2. Description of the Prior Art

In conventional technologies, data transmission between a PHY layer and a MAC layer is implemented in a parallel way under a pre-defined protocol, such as media independent interface (MII) or reduced media independent interface (reduced MII). If the PHY layer and the MAC layer are implemented in two different chips, a large amount of pins are required.

For systems having multi-gigabit bandwidth, no matter whether a gigabit media independent interface (GMII) or a reduced gigabit media independent interface (reduced GMII) is used as the parallel transmission interface between the PHY layer and the MAC layer, more and more pins are required. This is undesirable from the viewpoint of cost and system deployment.

### SUMMARY OF THE INVENTION

Therefore, one of the objectives of the present invention is to provide a communication apparatus that transmits data in the form of serial data, and a method thereof.

According to an embodiment of the present invention, a communication apparatus is disclosed. The communication apparatus comprises a first processing circuit, a parallel-to-serial converting unit, a transmitting interface, a serial-to-parallel converting unit, and a second processing circuit. The first processing circuit processes data of a first network layer to generate a first parallel data. The parallel-to-serial converting unit is coupled to the first processing circuit for generating a serial data according to the first parallel data generated by the first processing circuit. The transmitting interface is coupled to the parallel-to-serial converting unit for transmitting the serial data generated by the parallel-to-serial converting unit. The serial-to-parallel converting unit is coupled to the transmitting interface for converting the serial data transmitted by the transmitting interface into a second parallel data. The second processing circuit processes the second parallel data to generate data that corresponds to a second network layer, wherein a transmitting frequency of the transmitting interface is larger than the operating frequencies of the first and the second processing circuits.

According to a second embodiment of the present invention, a communication apparatus is disclosed. The communication apparatus comprises a first processing circuit, a parallel-to-serial converting unit, a transmitting interface, a serial-to-parallel converting unit, and a second processing circuit. The first processing circuit processes data of a first network layer to generate a first parallel data. The parallel-to-serial converting unit is coupled to the first processing circuit for generating a serial data according to the first parallel data generated by the first processing circuit. The transmitting interface is coupled to the parallel-to-serial converting unit for transmitting the serial data generated by the parallel-to-serial converting unit. The serial-to-parallel converting unit is coupled to the transmitting interface for converting the serial data transmitted by the transmitting interface into a second parallel data. The second processing circuit processes the second parallel data to generate data that corresponds to a second network layer, wherein the operating frequency of the first processing circuit is different from the operating frequency of the second processing circuit.

According to a third embodiment of the present invention, a communication apparatus is disclosed. The communication apparatus comprises a first processing circuit, a parallel-to-serial converting unit, a transmitting interface, a serial-to-parallel converting unit, and a second processing circuit. The first processing circuit processes data of a first network layer to generate a first parallel data. The parallel-to-serial converting unit is coupled to the first processing circuit for generating a serial data according to the first parallel data generated by the first processing circuit. The transmitting interface is coupled to the parallel-to-serial converting unit for transmitting the serial data generated by the parallel-to-serial converting unit. The serial-to-parallel converting unit is coupled to the transmitting interface for converting the serial data transmitted by the transmitting interface into a second parallel data. The second processing circuit processes the second parallel data to generate data that corresponds to a second network layer, wherein the first network layer and the second network layer correspond to a network layer with the same level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication apparatus according to an embodiment of the present invention.

FIG. 2 is a timing diagram illustrating the parallel data, the encoded parallel data, and the merged parallel data of the communication apparatus as shown in FIG. 1.

FIG. 3 is a diagram illustrating a serializer according to an embodiment of the present invention.

FIG. 4 is a flow chart illustrating a communicating method according to an embodiment of the present invention.

### DETAILED DESCRIPTION

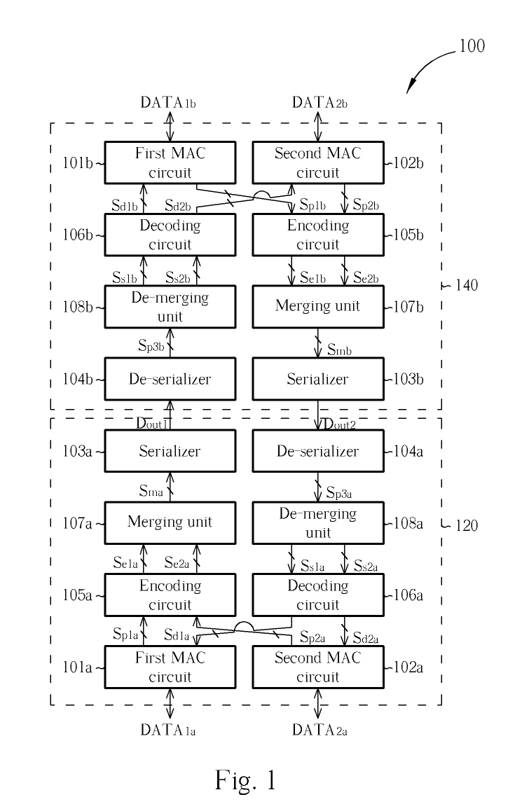

Please refer to FIG. 1. FIG. 1 is a diagram illustrating a communication apparatus 100 according to an embodiment of the present invention. The communication apparatus 100 comprises a first network terminal 120 and a second network terminal 140. In this embodiment, the first network terminal 120 comprises a first processing circuit (i.e. the first Media Access Control (MAC) Circuit 101a), a second processing circuit (i.e. the second Media Access Control Circuit 102a), a parallel-to-serial converting unit (i.e. the serializer 103a), a serial-to-parallel converting unit (i.e. the de-serializer 104a), an encoding circuit 105a, a decoding circuit 106a, a merging unit 107a, and a de-merging unit 108a.

According to the first network terminal 120, the first MAC Circuit 101a is utilized for processing data DATA₁ₐ that corresponds to the first network layer (i.e. the MAC layer in this embodiment) to generate a first parallel data Sₚ₁ₐ, and the first MAC Circuit 101a processes the data DATA₁ₐ that corresponds to the first network layer according to a first decoded parallel data S_{d1a}. The second MAC circuit 102a is utilized for processing data DATA₂ₐ that corresponds to the first network layer according to a second decoded parallel data S_{d2a}, and the second MAC circuit 102a processes the data DATA₂ₐ that corresponds to the first network layer to generate a second parallel data Sₚ₂ₐ. The serializer 103a converts the first parallel data Sₚ₁ₐ and the second parallel data Sₚ₂ₐ, outputted from the first MAC circuit 101a and the second MAC circuit 102a respectively, into a serial data Dₒᵤₜ₁. Then, the serial data Dₒᵤₜ₁ is transmitted through an interface, in which the interface can be an optical network, twisted pair cable or metallic conducting line, etc, to be input to the second network terminal 140. The de-serializer 104a is utilized for converting a serial data Dₒᵤₜ₂ outputted from the serializer 103b, into a third parallel data Sₚ₃ₐ. The encoding circuit 105a encodes the first parallel data Sₚ₁ₐ and the second parallel data Sₚ₂ₐ to generate a first encoded parallel data Sₑ₁ₐ and a second encoded parallel data Sₑ₂ₐ respectively. Furthermore, according to one embodiment of the present invention, the encoding circuit 105a is a scramble circuit, which scrambles the received parallel data. In this case, the serializer 103a generates the serial data Dₒᵤₜ₁ according to the first encoded parallel data Sₑ₁ₐ and the second encoded parallel data Sₑ₂ₐ. The decoding circuit 106a generates the first decoded parallel data S_{d1a} and the second decoded parallel data S_{d2a} according to the third parallel data Sₚ₃ₐ. Furthermore, according to one embodiment of the present invention, the decoding circuit 106a is a de-scramble circuit, which de-scrambles the received parallel data. In this case, the merging unit 107a is utilized for merging the first encoded parallel data Sₑ₁ₐ and the second encoded parallel data Sₑ₂ₐ, which are outputted by the encoding circuit 105a, to generate a merged parallel data Sₘₐ, wherein the serializer 103a converts the merged parallel data Sₘₐ into the serial data Dₒᵤₜ₁. The de-merging unit 108a is utilized for decomposing the third parallel data Sₚ₃ₐ to generate a first decomposed parallel data Sₛ₁ₐ and a second decomposed parallel data Sₛ₂ₐ, wherein the decoding circuit 106a decodes the first and the second decomposed parallel data Sₛ₁ₐ, Sₛ₂ₐ to generate the first decoded parallel data S_{d1a} and the second decoded parallel data S_{d2a} respectively.

The second network terminal 140 and the first MAC circuit 101b are utilized for processing data DATA_{1b} corresponding to the second network layer (i.e. the MAC layer in this embodiment) to generate a first parallel data S_{p1b}, and the first MAC circuit 101b processes the data DATA_{1b} corresponding to the second network layer according to a first decoded parallel data S_{d1b}. The second MAC circuit 102b is utilized for processing data DATA₂ₐ corresponding to the second network layer according to a second decoded parallel data S_{d2b}, and the second MAC circuit 102b processes the data DATA₂ₐ corresponding to the second network layer to generate a second parallel data S_{p2b}. The serializer 103b converts the first parallel data S_{p1b} and the second parallel data S_{p2b} outputted from the first MAC circuit 101b and the second MAC circuit 102b respectively, into a serial data Dₒᵤₜ₂. The de-serializer 104b is utilized for converting a serial data Dₒᵤₜ₁ outputted from the serializer 103a into a third parallel data S_{p3b}. The encoding circuit 105b encodes the first parallel data S_{p1b} and the second parallel data S_{p2b} to generate a first encoded parallel data S_{e1b} and a second encoded parallel data S_{e2b} respectively, wherein the serializer 103b generates the serial data Dₒᵤₜ₂ according to the first encoded parallel data S_{e1b} and the second encoded parallel data S_{e2b}. The decoding circuit 106b generates the first decoded parallel data S_{d1b} and the second decoded parallel data S_{d2b} according to the third parallel data S_{p3b}. Then, the merging unit 107b is utilized for merging the first encoded parallel data S_{e1b} and the second encoded parallel data S_{e2b}, which are outputted by the encoding circuit 105b, to generate a merged parallel data S_{mb}, wherein the serializer 103b converts the merged parallel data S_{mb} into the serial data Dₒᵤₜ₂. The de-merging unit 108b is utilized for decomposing the third parallel data S_{p3b} to generate a first decomposed parallel data S_{s1b} and a second decomposed parallel data S_{s2b}, wherein the decoding circuit 106b decodes the first and the second decomposed parallel data S_{s1b}, S_{s2b} to generate the first decoded parallel data S_{d1b} and the second decoded parallel data S_{d2b} respectively.

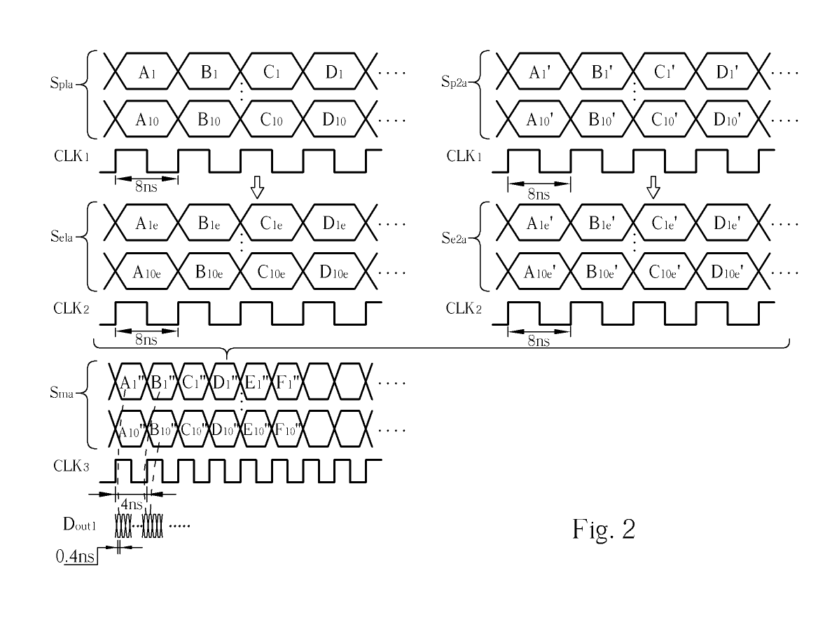

According to the embodiment of the present invention, when the MAC circuits 101a, 102a of the first network terminal 120 respectively transmit the first and the second parallel data Sₚ₁ₐ, Sₚ₂ₐ to the MAC circuits 101b, 102b of the second network terminal 140, the data types of both the first parallel data Sₚ₁ₐ and the second parallel data Sₚ₂ₐ are ten parallel output data, in which the bit rate of each output data is 125 Mbit/s (i.e. the period of each data is 8 ns). Furthermore, the first parallel data Sₚ₁ₐ is synchronized with a clock CLK₁ (125 MHz) as shown in FIG. 2. FIG. 2 is a timing diagram illustrating the parallel data Sₚ₁ₐ, Sₚ₂ₐ, the encoded parallel data Sₑ₁ₐ, Sₑ₂ₐ, and the merged parallel data Sₘₐ of the communication apparatus 100 as shown in FIG. 1. When the parallel data Sₚ₁ₐ, Sₚ₂ₐ is inputted into the encoding circuit 105a, the encoding circuit 105a encodes the parallel data Sₚ₁ₐ, Sₚ₂ₐ to output the encoded parallel data Sₑ₁ₐ, Sₑ₂ₐ, in which the data types are ten parallel output data, the bit rate of each output data is 125 Mbit/s, and the parallel data Sₚ₁ₐ, Sₚ₂ₐ are synchronized with a clock CLK2 (125 MHz) as shown in FIG. 2. According to the embodiment of the present invention, the encoding circuit 105a is utilized for providing the required information upon the parallel data Sₚ₁ₐ, Sₚ₂ₐ when transmitting, such as encryption, scrambling the transmitted data in order to obtain a tolerable data disorder to avoid the DC balance phenomenon, and providing the controlling information upon the transmitted data in order to improve the accuracy upon receiving the data. Then, the encoded parallel data Sₑ₁ₐ, Sₑ₂ₐ are inputted to the merging unit 107a at substantially the same time for generating a merged parallel data Sₘₐ, where the data type of the merged parallel data Sₘₐ is the ten parallel data. Therefore, the merged parallel data Sₘₐ comprises the output information of the MAC circuits 101a and 102a. Accordingly, the bit rate of each of the output data of the merged parallel data Sₘₐ is 250 Mbit/s (i.e. the period of each data is 4 ns). The merged parallel data Sₘₐ is synchronized with a clock CLK₃ (250 MHz) as shown in FIG. 2. Then, the merged parallel data Sₘₐ is inputted into the serializer 103a in order to generate a high frequency serial data Dₒᵤₜ₁. Therefore, the bit rate of the outputted serial data Dₒᵤₜ₁ is 2.5 Gbit/s, i.e. the period of each data is 0.4 ns.

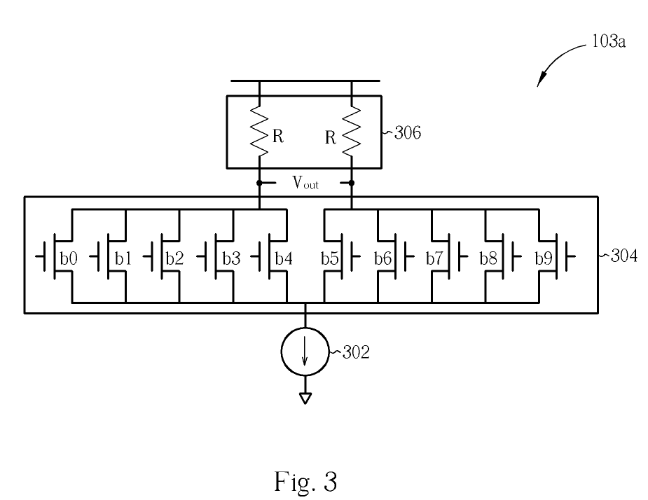

Please refer to FIG. 3. FIG. 3 is a diagram illustrating the serializer 103a according to an embodiment of the present invention. The serializer 103 comprises a current unit 302, transistor unit 304, and a loading unit 306, wherein the loading unit 306 can be implemented by a resistor R. When the serializer 103a receives the parallel data Sₘₐ outputted from the merging unit 107a through the transistor unit 304, the conductivity of the transistors b0˜b09 are dependent on the parallel data Sₘₐ. Accordingly, the current of the current unit 302 flows through the resistor R by the conductance of the transistor, to thereby generate the output voltage Vₒᵤₜ that corresponds to the parallel data Sₘₐ, in which the output voltage Vₒᵤₜ represents the serial data Dₒᵤₜ₁. Then, the serial data Dₒᵤₜ₁ is transmitted to the second network terminal 140 through a transmitting interface. Please note that, according to the embodiment communication apparatus 100 of the present invention, the first network terminal 140 also comprises a synchronize controller (not shown) coupled to the de-serializer 104b for generating a clock controlling signal to the de-serializer 104b, in order to synchronize the serial data Dₒᵤₜ₁ received by the de-serializer 104b.

Please note that the first network terminal 120 and the second network terminal 140 are not limited to be in the above-mentioned MAC layer, and can be in the PHY layer, or any combination between the MAC layer and the PHY layer, which also belongs to the scope of the present invention. In other words, the first MAC circuits 101a, 101b and the second MAC circuits 102a, 102b can be replaced by PHY circuits according to the configuration of the communication apparatus 100. For example, according to another embodiment of the present invention, the first MAC circuits 101a, 101b and the second MAC circuits 102a, 102b are replaced by PHY circuits to process the data transmission between the two PHY layers. According to another embodiment of the present invention, the first MAC circuit 101 a and the second MAC circuit 102a are replaced by PHY circuits, and thus the communication apparatus 100 is capable of processing the data transmission between the PHY layer and the MAC layer. Furthermore, the first network terminal 120 and the second network terminal 140 can be operated under different operating frequencies. For example, the first network terminal 120 operates at 100 MHz, while the second network terminal 140 operates at 1000 MHz, and the serializer is utilized for converting the transmitted data into serial type for outputting to the transmitting interface.

When the first network terminal 120 and the second network terminal 140 are installed in different chips, an optical network can be implemented between the first network terminal 120 and the second network terminal 140 for long distance transmission of the serial data Dₒᵤₜ₁, Dₒᵤₜ₂. For example, the transmission of the serial data Dₒᵤₜ₁, Dₒᵤₜ₂ is accomplished via the optical network installed between the serializer 103a and de-serializer 104b, and the serializer 103b and de-serializer 104a as shown in FIG. 1. Furthermore, when the first network terminal 120 and the second network terminal 140 of the embodiment of the present invention are applied in the PHY layer, the data DATA₁ₐ, DATA₂ₐ, DATA_{1b}, DATA_{2b} can be transmitted via the twisted-pair cable. Furthermore, according to another embodiment of the present invention, the first network terminal 120 and the second network terminal 140, as shown in FIG. 1, are applied in the PHY layer, and the data DATA₁ₐ, DATA₂ₐ, DATA_{1b}, DATA_{2b} are transmitted via the twisted-pair cable. According to another embodiment of the present invention, the first network terminal 120 and the second network terminal 140, as shown in FIG. 1, are applied in the PHY layer, the data DATA₁ₐ, DATA₂ₐ, DATA_{1b}, DATA_{2b} are transmitted via the twisted-pair cable, but the serial data Dₒᵤₜ₁, Dₒᵤₜ₂ are transmitted via the optical network. According to another embodiment of the present invention, the first network terminal 120 and the second network terminal 140, as shown in FIG. 1, are applied in the PHY layer, the data DATA₁ₐ, DATA₂ₐ, DATA_{1b}, DATA_{2b} are transmitted via the optical network, and the serial data Dₒᵤₜ₁, Dₒᵤₜ₂ are also transmitted via the optical network. According to another embodiment of the present invention, the first network terminal 120 and the second network terminal 140, as shown in FIG. 1, are applied in the PHY layer, and the data DATA₁ₐ, DATA₂ₐ, DATA_{1b}, DATA_{2b} are transmitted via the optical network. Furthermore, when the first network terminal 120 and the second network terminal 140 are installed in a single chip, the serial data Dₒᵤₜ₁, Dₒᵤₜ₂ can be transmitted via the metallic path within the single chip.

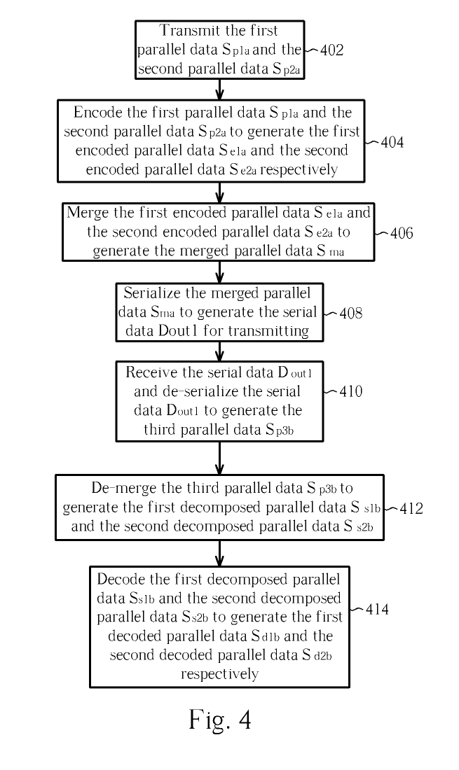

Please refer to FIG. 4. FIG. 4 is a flow chart illustrating a communicating method according to an embodiment of the present invention. Please note that the communicating method can be implemented by the communication apparatus 100 as shown in FIG. 1. The communicating method is briefly described in the following steps:

Step 402: Transmit the first parallel data Sₚ₁ₐ and the second parallel data Sₚ₂ₐ;

Step 404: Encode the first parallel data Sₚ₁ₐ and the second parallel data Sₚ₂ₐ to generate the first encoded parallel data Sₑ₁ₐ and the second encoded parallel data Sₑ₂ₐ respectively;

Step 406: Merge the first encoded parallel data Sₑ₁ₐ and the second encoded parallel data Sₑ₂ₐ to generate the merged parallel data Sₘₐ;

Step 408: Serialize the merged parallel data Sₘₐ to generate the serial data Dₒᵤₜ₁ for transmitting;]

Step 410: Receive the serial data Dₒᵤₜ₁ and de-serialize the serial data Dₒᵤₜ₁ to generate the third parallel data S_{p3b};

Step 412: De-merge the third parallel data S_{p3b} to generate the first decomposed parallel data S_{s1b} and the second decomposed parallel data S_{s2b}; and

Step 414: Decode the first decomposed parallel data S_{s1b} and the second decomposed parallel data S_{s2b} to generate the first decoded parallel data S_{d1b} and the second decoded parallel data S_{d2b} respectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus, comprising:
a first processing circuit, for processing data of a first network layer to generate a first parallel data;
a parallel-to-serial converting unit, coupled to the first processing circuit, for generating a serial data according to the first parallel data generated by the first processing circuit;
a transmitting interface, coupled to the parallel-to-serial converting unit, for transmitting the serial data generated by the parallel-to-serial converting unit;
a serial-to-parallel converting unit, coupled to the transmitting interface, for converting the serial data transmitted by the transmitting interface into a second parallel data; and
a second processing circuit, for processing the second parallel data to generate data corresponding to a second network layer;
wherein a transmitting frequency of the transmitting interface is larger than the operating frequencies of the first and the second processing circuits.

2. The communication apparatus of claim 1, wherein the first network layer and the second network layer correspond to a network layer with same level.

3. The communication apparatus of claim 1, wherein the first network layer is one of a media access controlling (MAC) layer and physical (PHY) layer, and the second network layer is one of the media access controlling layer and physical layer.

4. The communication apparatus of claim 1, wherein the first processing circuit has a first operating frequency; the second processing circuit has a second operating frequency; and the first operating frequency is different from the second operating frequency.

5. The communication apparatus of claim 1, further comprising:
an encoding circuit, for encoding the data of the first network layer to generate the first parallel data; and
a decoding circuit, for decoding the second parallel data to generate the data of the second network layer.

6. The communication apparatus of claim 5, wherein the encoding circuit scrambles the data of the first network layer, and the decoding circuit de-scrambles the second parallel data.

7. The communication apparatus of claim 1, wherein the parallel-to-serial converting unit comprises:
a loading device; and
a plurality of cascoded transistors, coupled to the loading device for receiving the first parallel data, converting the first parallel data into the serial data and outputting the serial data to the loading device.

8. The communication apparatus of claim 1, further comprising:
a synchronize controller, coupled to the serial-to-parallel converting unit, for generating a clock controlling signal to the serial-to-parallel converting unit to synchronize the data of the communication apparatus.

9. The communication apparatus of claim 1, wherein the transmitting interface is an optical network.

10. The communication apparatus of claim 1, wherein the transmitting interface is an Ethernet.

11. A communicating method, comprising:
processing data of a first network layer with a first operating frequency to generate a first parallel data;
serializing the first parallel data to generate a serial data;
utilizing a transmitting interface to transmit the serial data;
receiving the serial data and parallelizing the serial data to generate a second parallel data; and
processing the second parallel data with a second operating frequency to generate data corresponding to a second network layer;
wherein a transmitting frequency of the serial data is larger than the first operating frequency and the second operating frequency.

12. The communicating method of claim 11, wherein the first network layer and the second network layer correspond to a network layer with same level.

13. The communicating method of claim 11, wherein the first network layer is one of a media access controlling (MAC) layer and physical (PHY) layer, and the second network layer is one of the media access controlling layer and physical layer.

14. The communicating method of claim 11, wherein the first operating frequency is different from the second operating frequency.

15. The communicating method of claim 11, further comprising:
encoding the data of the first network layer to generate the first parallel data; and
decoding the second parallel data to generate the data of the second network layer.

16. The communicating method of claim 15, wherein the step of encoding the data of the first network layer comprises scrambling the data of the first network layer, and the step of decoding the second parallel data comprises de-scrambling the second parallel data.

17. The communicating method of claim 11, wherein the step of serializing the first parallel data comprises:
cascoding a plurality of transistors; and
utilizing the plurality of transistors to convert the first parallel data into a loading device.

18. The communicating method of claim 11, further comprising:
generating a clock controlling signal to synchronize the data transmitted in the communicating method.

19. The communicating method of claim 11, wherein the transmitting interface is an optical network.

20. The communicating method of claim 11, wherein the transmitting interface is an Ethernet.
